(19) United States
(12) Patent Application Publication
(10) Pub. No.: US 2003/0146261 A1
(43) Pub. Date: Aug. 7, 2003

(54) Cap connection cord for stapling gun

(76) Inventor: Chen-Fa Huang, Ta Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/060,771

(22) Filed: Feb. 1, 2002

(51) Int. Cl. B25C 7/00

(52) U.S. Cl. 227/15

(57) ABSTRACT

A cap connection cord for connecting caps includes a ring connected to a first end of the cord and the cord frictionally fits in the hole in each of the caps. The pile of caps is conveniently put in a cylinder attached to the stapling gun and the cord can be pulled out from the central holes of the caps.

### FIELD OF THE INVENTION

The present invention relates to a cap connection cord which has a ring and extends through caps. A small flange is connected to a lower end of the cord so as to maintain the pile of the caps.

### BACKGROUND OF THE INVENTION

A conventional cap feeding device attached to a stapling gun 12 is shown in FIG. 1 and includes a positioning means 13 connected to a side of the stapling gun 12 and a spring 15 with a pushing rod 16 extends through the positioning means 13. A plate 14 is connected to the nose of the stapling gun 12 and has a groove to receive the caps 10 therein. The caps 10 are piled up in a tube 11 which is engaged between the plate 14 and the positioning means 13. The pushing rod 16 has a pushing end 161 which pushes the top one of the pile of the caps 10 toward the plate 14 so that the caps 10 are fed in the groove one by one. A pneumatic system (not shown) is used to push the caps 10 in the groove to be fed so that a staple or nail may extend through a central hole of the cap 10 fed below the nose of the stapling gun 12. However, the tube 11 and the pile of the caps 10 are assembled to be a assembly by the manufacturers when the user purchases assembly so that the user cannot open the tube to adjust any cap in the tube 11. Therefore, once one of the caps 10 is stocked in the tube 11, the whole assembly is to be discarded. This is not benefit to the users and has to be improved.

### SUMMARY OF THE INVENTION

In accordance with one aspect of the present invention, there is provided a cap connection cord for connecting caps which has a central hole in each of the caps. The connection cord has a ring connected to a first end thereof and the cord frictionally fits in the hole in each of the caps.

The primary object of the present invention is to provide a connection cord that frictionally extends through the central holes of a pile of caps and the cord is conveniently pulled out from the central holes when the caps are put in the cylinder of the feeding device of the stapling gun.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a stapling gun and a conventional tube in which the caps are received;

FIG. 2 is a cross sectional view to show that the conventional tube with the caps therein is engaged with the pushing rod;

FIG. 3 is a cross sectional to show the pile of caps are connected by the connection cord of the present invention;

FIG. 4 is a perspective view to show the pile of caps are connected by the connection cord of the present invention, and

FIG. 5 is a cross sectional view to show that the pile of caps are connected by the cord of the present invention and connected to the pushing rod.

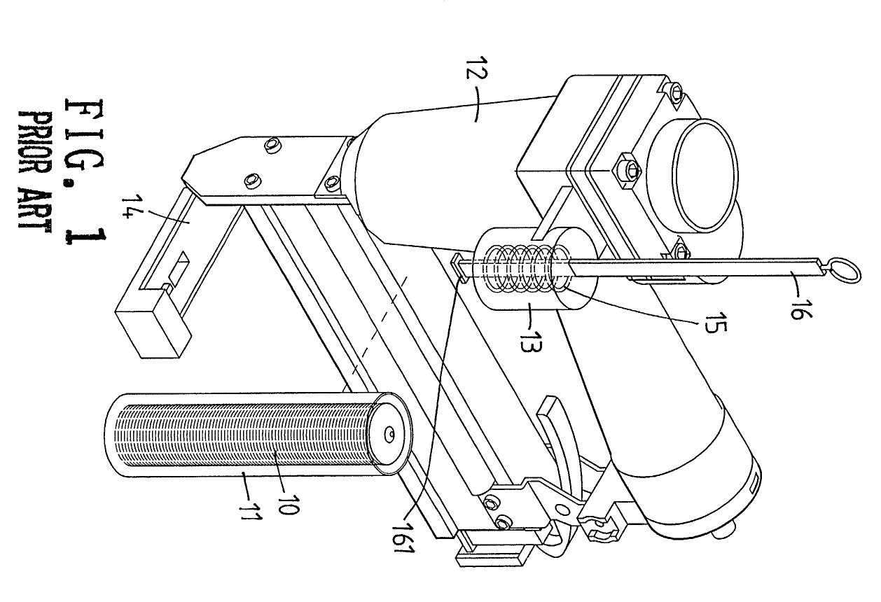

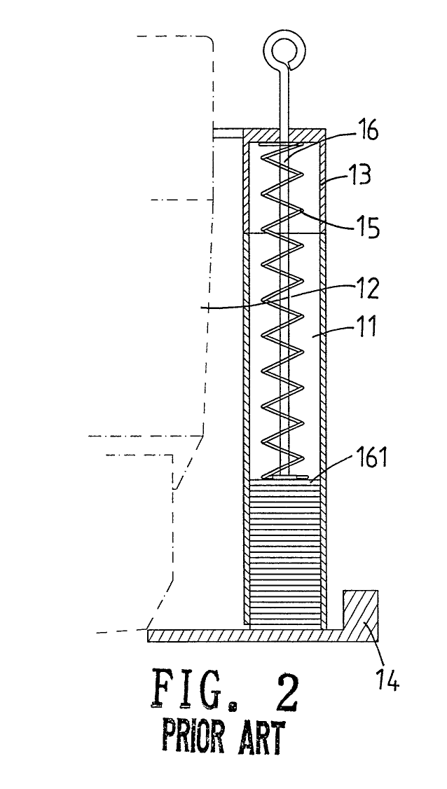

### DETAILED DESCRIPTION OF THE PREFERRED EMBODIMENT

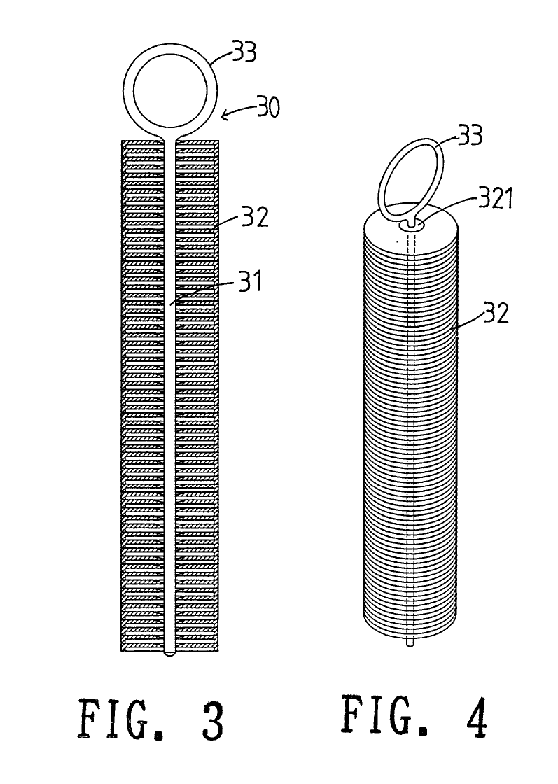

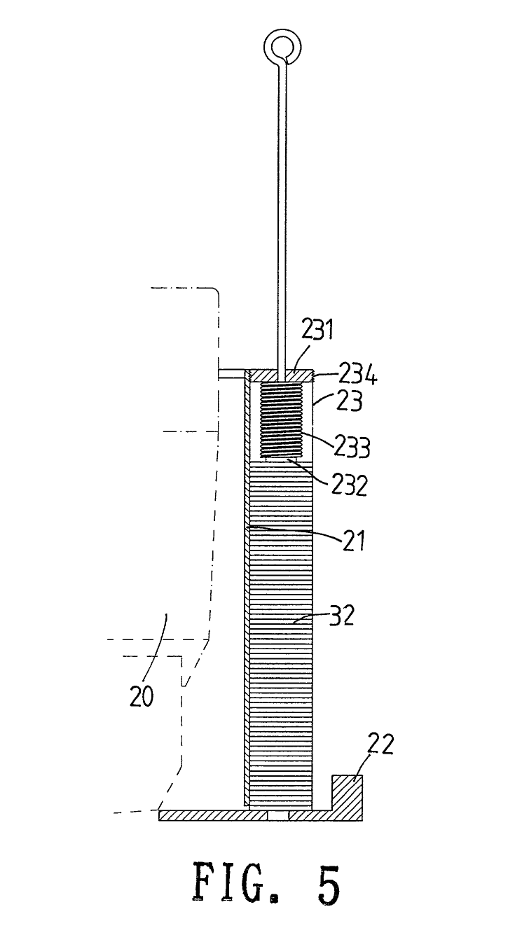

Referring to FIGS. 3 to 5, the connection cord 30 for connecting caps 32 of the present invention comprises a ring 33 connected to a first end of the cord 30 and the cord 30 frictionally extends through the hole 321 in each of the caps 32. The friction collects the caps 32 to be connected to the cord 30.

The pile of the caps 32 collected by the cord 30 can be easily brought to be put in the cylinder 21 attached to the stapling gun 20 and the cord 30 is then pulled out from the pile of the caps 32 by lifting the ring 33 till the cord 30 is completely removed from the pile of the caps 32. A threaded inner periphery is defined in the open top of the cylinder 21 and a pushing means 23 is engaged with the open top of the cylinder 21. The pushing means 23 includes a cover 231 which has a threaded outer periphery 234 which is threadedly connected to the threaded inner periphery of the cylinder 21. A pushing rod is cooperated with a spring 233 and includes a pushing end 232 which pushes the caps 32 toward the plate 22 connected to the nose of the stapling gun 20.

The caps 32 are connected as a pile by simply a cord 30 which occupies much less space in comparison with the conventional tube.

While we have shown and described the embodiment in accordance with the present invention, it should be clear to those skilled in the art that further embodiments may be made without departing from the scope of the present invention.

What is claimed is:

1. A cap connection cord for connecting caps with a central hole in each of the caps, the connection cord comprising:
a ring connected to a first end of the cord and the cord adapted to frictionally fit in the hole in each of the caps.

2. The cap connection cord as claimed in claim 1, wherein a flange is connected to a second end of the cord, the flange being made by flexible material and a diameter of the flange adapted to be slightly larger than the central hole of the caps.
